(19) United States
(12) Patent Application Publication
(10) Pub. No.: US 2021/0365341 A1
(43) Pub. Date: Nov. 25, 2021

(54) LEDGER-BASED DEVICE HEALTH DATA SHARING

(71) Applicant: Seagate Technology LLC, Cupertino, CA (US)

(72) Inventors: Bijoyendra Nath, Edina, MN (US); Scott Robert Warmka, Burnsville, MN (US)

(21) Appl. No.: 16/879,175

(22) Filed: May 20, 2020

(51) Int. Cl. G06F 11/30; H04L 9/06

(52) U.S. Cl. CPC G06F 11/3055; H04L 2209/38; H04L 9/0643; H04L 9/0637

(57) ABSTRACT

A system, apparatus, and method may include an electronic device node configured to generate device health data indicative of electronic device health. A ledger node may store a shared ledger. The shared ledger may use blockchain or encryption techniques and may store encrypted data, data pointers, or transfer data. The shared ledger may be accessible by at least two parties to share particular device health data.

Techniques of the present disclosure relate to device health and in particular to sharing device health data between parties.

### SUMMARY

In one aspect, the present disclosure relates to a system including an electronic device node configured to generate device health data indicative of electronic device health. The system also includes a ledger node configured to store a blockchain comprising one or more blocks. The system further includes a block generating node configured to generate a new block based on the device health data and data corresponding to the one or more blocks in the blockchain. The block generating node is also configured to add the new block to the blockchain.

In another aspect, the present disclosure relates to an apparatus including memory configured to store a shared ledger comprising one or more blocks. The apparatus also includes a communication interface operably configured to receive device health transfer data corresponding to data indicative of electronic device health transferred from a source node to a destination node. The device health transfer data includes the data indicative of electronic device health, a source node address, and a destination node address. The apparatus also includes processing circuitry operably coupled to the memory and the communication interface. The processing circuitry is configured to generate a new block based on the device health transfer data. The processing circuitry is also configured to add the new block to the shared ledger.

In another aspect, the present disclosure relates to a method including: generating device health data indicative of electronic device health of an electronic device; generating a new block comprising at least partial encrypted device health data or one or more device health data pointers based on at least part of the device health data; adding the new block to a shared ledger stored on a ledger node; and sending at least part of the shared ledger to a device health analysis node remote from the ledger node. The electronic device is inaccessible by the device health analysis node.

The above summary is not intended to describe each embodiment or every implementation of the present disclosure. A more complete understanding will become apparent and appreciated by referring to the following detailed description and claims taken in conjunction with the accompanying drawings. In other words, these and various other features and advantages will be apparent from a reading of the following detailed description.

### BRIEF DESCRIPTION OF THE DRAWINGS

The disclosure may be more completely understood in consideration of the following detailed description of various embodiments of the disclosure in connection with the accompanying drawings.

FIG. 1 is a conceptual diagram that illustrates one example of a system for ledger-based sharing of device health data.

FIG. 2 is a conceptual diagram that illustrates one example of a ledger data structure that may be used to store a shared ledger usable in the system of FIG. 1.

FIG. 3 is a conceptual diagram that illustrates one example of a node usable in the system of FIG. 1.

FIG. 4 is a conceptual diagram that illustrates one example of a centralized system usable to configure the system of FIG. 1.

FIG. 5 is a conceptual diagram that illustrates one example of a decentralized system usable to configure the system of FIG. 1.

FIG. 6 is a flow diagram that illustrates one example of a blockchain verifying method for ledger-based sharing of device health data usable with any of the systems of FIGS. 1, 3, and 4.

FIG. 7 is a flow diagram that illustrates one example of a transaction recording method for ledger-based sharing of device health data usable with any of the systems of FIGS. 1, 3, and 4.

FIG. 8 is a flow diagram that illustrates one example of an encryption or pointer method for ledger-based sharing of device health data usable with any of the systems of FIGS. 1, 3, and 4.

### DETAILED DESCRIPTION

The present disclosure relates to device health and in particular to sharing device health data between parties. Various techniques may be used to store device health data between parties using a shared ledger to facilitate data integrity, auditability, and data security.

As used herein, a “node” or “electronic computing node” refers to an electronic computing system or device, which may include processing circuitry and memory, that is operably coupled to one or more other nodes to store or transfer data, such as a ledger, device health data, or data indicative of device health data, to form a ledger network or ledger system. A node may also be described as an electronic device node. Operable coupling may include a direct connection as part of a system, which may use a bus, or a network connection as part of a network, which may use an intranet or the internet.

A node may be managed or owned by a party, which may be described a first party, second party, or third party. A first party may be described as a user, client, customer, or enterprise. A second party may be in a contractual relationship with the first party, for example, to manage enterprise health, and may be described as a service provider, a seller, a manufacturer, or remote service. A third party may be in a contractual relationship with one or both of the first party and the third party, for example, to host a server, and may also be described as a service provider or remote service. Different parties may be separated by geographic location or by firewall.

As used herein, a “private node” refers to a node including data inaccessible to one or more other nodes in the ledger network or ledger system. In one example, a private data storage device may include sensitive user or otherwise proprietary data, which may be inaccessible to other nodes, such as a ledger node or a remote reliability analysis node described herein. In some cases, a private node is described as being owned by a first party.

As used herein, the term “inaccessible node” refers to a node that is not operably coupled to another node to allow communication with or a data transfer directly between the nodes. In some embodiments, inaccessibility may be partial and allow only particular communications or data to be transferred directly between the nodes. In one example, a configuration may prevent data on a private node from being transferred to a remote reliability analysis node, which may not even be able to communicate with or request data from the private node. Certain data, such as only device health data, from the private node may be transferred to an intermediary node, such as a ledger node. The remote reliability analysis node may access data on the intermediary node.

As used herein, the term “remote node” refers to a node that is operably coupled to another node that is part of another system or network, for example, owned by a different party or having different user access rights. In one example, a private node owned and accessible by a first party may be inaccessible by a second party. The different systems or networks may be separated by a firewall operably coupled between the nodes.

As used herein, “device health data” refers to data indicative of electronic device health. In one example, device health data may include one or more of the following: reliability data (such as S.M.A.R.T. data), usage data (performance data), and configuration data (hardware or software configuration data). In some embodiments, device health data may also be described as drive health data when the electronic device is an electronic data storage device, such as a hard disk drive, solid state drive, hybrid drive, etc.

As used herein, the term “ledger” refers to an electronic data structure that stores ledger data. Each entry to a ledger may be described as a transaction or a block (e.g., a data block). Each block may be recorded or added to the ledger. In some aspects, the ledger data includes device health data, which may or may not be encrypted. In some aspects, the ledger data includes one or more data pointers each corresponding to a location, or address, of device health data stored on a different node. A ledger may be a centralized ledger or a decentralized ledger. A centralized ledger may store all ledger data on one node. A decentralized ledger may be stored on a plurality of nodes. In particular, a decentralized ledger may store only some of or all the ledger data on each node of the plurality of nodes.

A ledger may be private or public. In general, a public ledger may be accessible, or at least readable, by any party, even though certain parts of the ledger may be encrypted or otherwise protected from extracting certain information from the ledger data. In general, a private ledger may be accessible by only certain parties. A public ledger may benefit from having more computational nodes available to facilitate processing, which may be helpful when using cryptographic techniques to implement the ledger. In general, a private ledger may be accessible by only certain parties and may facilitate more restricted access to ledger data.

As used herein, the term “blockchain” refers to a type of ledger formed using one or more blocks. Each block may be added to the blockchain in succession, for example, sequentially or one or more at a time. In general, each block may be configured to include data to facilitate verification of one or more previous blocks in the blockchain to protect against tampering. In some aspects, each block may contain a cryptographic hash of a previous one or more blocks. Each block may include stored block data and optionally a block header. Block header and stored block data may be readable by one or more other nodes in a blockchain, or ledger, network operably coupled to the node storing the blockchain. The block header may also be described as block meta data. The block header may include the cryptographic hash one or more of: a previous one or more blocks, a timestamp, and transaction data. Blocks added to the blockchain may include one or more multiple transactions.

Reference will now be made to the drawings, which depict one or more aspects described in this disclosure. However, it will be understood that other aspects not depicted in the drawings fall within the scope of this disclosure. Like numbers used in the figures refer to like components, steps, and the like. However, it will be understood that the use of a reference character to refer to an element in a given figure is not intended to limit the element in another figure labeled with the same reference character. In addition, the use of different reference characters to refer to elements in different figures is not intended to indicate that the differently referenced elements cannot be the same or similar.

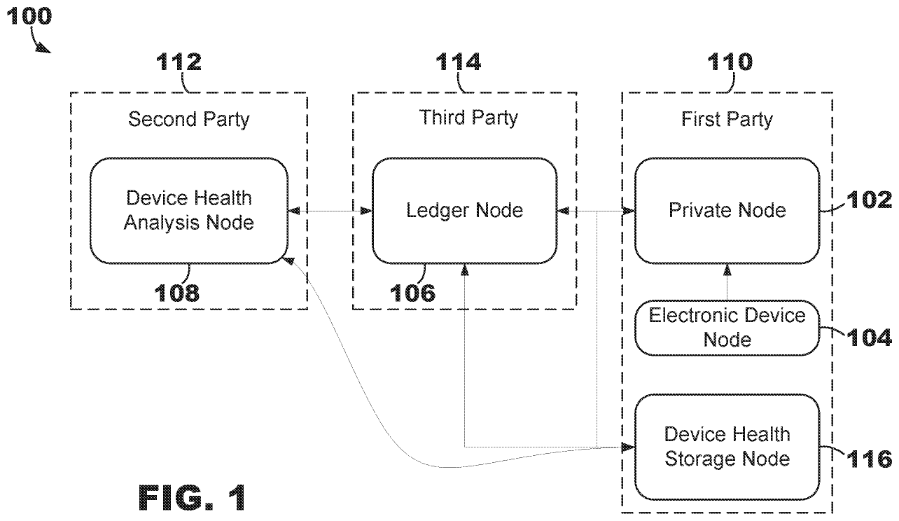

FIG. 1 is a conceptual diagram that illustrates one example of a system 100 for ledger-based sharing of device health data. The system 100 may include a private node 102, an electronic device node 104, a ledger node 106, a device health analysis node 108, and an optional device health storage node 116. In general, data transfer between various components of the system 100 may include one-way communication or two-way communication. The electronic device node 104 may be operably coupled to the private node 102 to transfer data, such as device health data, to the private node 102. The private node 102 may be operably coupled to the ledger node 106 to transfer data, such as ledger data, between the private node 102 and the ledger node 106. The ledger node 106 may be operably coupled to the device health analysis node 108 to transfer data, such as ledger data, between the ledger node 106 and the device health analysis node 108.

The device health storage node 116 may also be operably coupled to the private node 102, ledger node 106, and the device health analysis node 108. In some aspects, the device health storage node 116 may store device health data, which may be referenced by one or more device health data pointers stored on the ledger node 106. The device health analysis node 108 may at least read data from the ledger node 106 or the device health storage node 116.

Each component of the system 100 may be defined as being part of a network, or subsystem, corresponding to a particular party. In some aspects, the nodes may be part of least two different party networks of the system 100 (e.g., at least a first party network and a second party network. In the illustrated embodiment, the private node 102, the electronic device node 104, and the device health storage node 116 are part of a first party network 110, the device health analysis node 108 is owned by a second party network 112, and the ledger node 106 is owned by a third party network 114. In other embodiments, the ledger node 106 may be part of either the first party network 110 or the second party network 112 and a third party network 114 may not be used. In some aspects, the first party network 110 may be a customer, the second party network 112 may be an electronic device provider, and the third party network 114 may be a cloud-based provider. In other embodiments (not shown), the device health analysis node 108 may also be part of the first party network 110, which may be accessible by another node that is part of the second party network 112.

In general, the system 100 is configured to provide a shared ledger to facilitate trusted sharing of data between parties. A shared ledger may be at least read accessible by two or more parties. At least one party may be able to write to the shared ledger. In some cases, data to be shared and data to be kept private may both be stored on the electronic device node 104. The shared ledger may facilitate trusted sharing of only the data allowed to be shared while keeping the data to be kept private from being accessible by other parties.

In some aspects, the electronic device node 104 is inaccessible by one or more other nodes, such as the device health analysis node 108. In particular, in some aspects, private data stored by the electronic device node 104. At least the private data may be inaccessible by the one or more other nodes, such as the device health analysis node 108, and device health data stored by the electronic device node 104 may be accessible by the device health analysis node 108. For example, the device health analysis node 108 may be able to directly access device health data on the electronic device node 104 or indirectly access device health data through the shared ledger.

Various nodes may be configured to be in one-way communication with one another. In some aspects, data may be transferred only from the electronic device node 104 to the private node 102. The private node 102 may not be able to access any information on the electronic device node 104 that is not transmitted, or “pushed,” by the electronic device node 104. In some aspects, data may be transferred only from the private node 102 to the ledger node 106. The ledger node 106 may not be able to access any information on the private node 102 that is not recorded, or “pushed,” by the private node 102 to the shared ledger. In some aspects, data may be transferred only one-way from the ledger node 106 to the device health analysis node 108. The device health analysis node 108 may be configured to provide only a read request to the ledger node 106.

The private node 102 may be configured to generate device health data indicative of electronic device health. In some aspects, the device health data generated may be indicative of the health of one or more electronic devices, such as the electronic device node 104.

The ledger node 106 may be configured to store the shared ledger. The shared ledger may be a centralized ledger or a copy of a decentralized ledger. In some aspects, ledger data in the shared ledger may be stored in a blockchain. The one or more blocks of the shared ledger may include at least partial device health data, at least partial encrypted device health data, or one or more device health data pointers.

Any suitable encryption technique may be used known to one skilled in the art having the benefit of this disclosure. A non-limiting example of an encryption technique may use private and/or public key encryption. Partial encrypted device health data may be described as storing drive health data with only part of the drive health data being encrypted or storing and encrypting only part of the drive health data.

Any suitable data pointer may be used for a device health data pointer. In general, a device health data pointer may include an address indicating the location of data stored on a different node and/or in a different data structure. In some aspects, a device health data pointer may indicate an address of data in a device health data structure indicative of electronic device health, such as the device health storage node 116. The device health data structure may include one or more of the following: at least partial device health data and at least partial encrypted device health data. In some aspects, the device health storage node 116 may be described as a particular type of ledger node.

In some aspects, one or more blocks of the shared ledger may include device health transfer data. Device health transfer data may be used to track which nodes have sent or received device health data. Each block of device health transfer data may correspond to data indicative of electronic device health transferred from a source node to a destination node. In some examples, device health transfer data may include a source node address and a destination node address. Device health transfer data may also include or identify data indicative of device health being shared from the source node to the destination node.

Cryptocurrency techniques, such as digital signatures, may be used to record the transfer of (or transaction) of data from a source node to a destination node. Each respective node may be associated with a unique address or identifier (ID), which may be identified in the device health transfer data.

One or more nodes of the system 100, such as the private node 102 or the ledger node 106, may be used to generate a new block. The new block may be added to the shared ledger. In some aspects, a new block may be generated based on device health data and data corresponding to one or more blocks in the shared ledger, particularly when the ledger is a blockchain. In some aspects, a new block may be generated based on device health transfer data. Each block in the shared ledger may correspond to data from one or more electronic device nodes, such as electronic device node 104.

The device health analysis node 108 may be configured to determine a device health status, such as of one or more electronic device nodes. The device health status may be determined based on at least part of the ledger data. Non-limiting examples of a device health status include a used service life parameter or a remaining service life parameter. The used and remaining service life parameters may be determined, for example, based on a number of bits passed or time duration parameter. The time duration parameter may relate to a number of years in service or a number of powered on hours. In some aspects, the second party 112 may provide an indication to the first party 110 of the device health status, which may be used by the first party 110 to make decisions regarding the one or more electronic devices nodes 104, such as potential maintenance before failure or repairs after failure. In some cases, the device health analysis node 108 may provide the indication of the device health status (including transmission of the device health status) to a node of the system 100, such as the ledger node 106, the private 102, or the device health storage node 116.

In some aspects, when at least partial device health data is encrypted on the shared ledger on ledger node 106 or device health storage node 116, the at least partial encrypted device health data may be decrypted by the device health analysis node 108 before determining the device health status of the electronic device node 104. In some aspects, the device health analysis node 108 may use a private key for decryption, which may be shared between at least the private node 102 and the device health analysis node 108. The private key may be used by the private node 102 to generate the encrypted device health data and used by the device health analysis node 108 to decrypt the encrypted device health data.

In some aspects, the system 100 may use a shared ledger that uses a blockchain to store ledger data. The blockchain may be used to protect against tampering of information recorded to the shared ledger or to facilitate integrity of the recorded information. In particular, the blockchain may allow verification that each previous block has not been tampered. The blockchain may be audited to verify whether tampering has occurred with one or more blocks. Any suitable technique to implement the shared ledger as a blockchain may be used as known to one skilled in the art having the benefit of this disclosure. In one example, information about one or more previous blocks may be included in each new block that is added or recorded to the shared ledger and optionally cryptographically hashed, which may reduce the amount of data required to store in each block while facilitating verification.

In some aspects, the system 100 may use a shared ledger that stores information about the transfer of data between various nodes in the ledger data. A record of data transfer may facilitate ensuring information is shared to appropriate nodes. In particular, the transfer data may allow verification of which nodes received particular data and which nodes have transmitted particular data. The shared ledger including transfer data may be audited to verify that only designated nodes, for example, according to an agreement by the parties. Any suitable technique to implement the shared ledger with transfer data may be used as known to one skilled in the art having the benefit of this disclosure. In one example, each time data is transferred from one node to another node, the shared ledger may record information identifying the transferred data and a source node address and a destination node address corresponding to the transferred data.

In some aspects, the system 100 may be configured to store data different than the device health data on a shared ledger, which may facilitate security of data shared between parties using the ledger. Any suitable technique to implement storing different data on the shared ledger may be used as known to one skilled in the art having the benefit of this disclosure. In some examples, the shared ledger may include encrypted data or pointer data. Encryption or the user of pointers may prevent unauthorized users who access the shared ledger from extracting information from the shared ledger without a private key or without access to the node actually storing the data, such as the device health storage node 116, respectively.

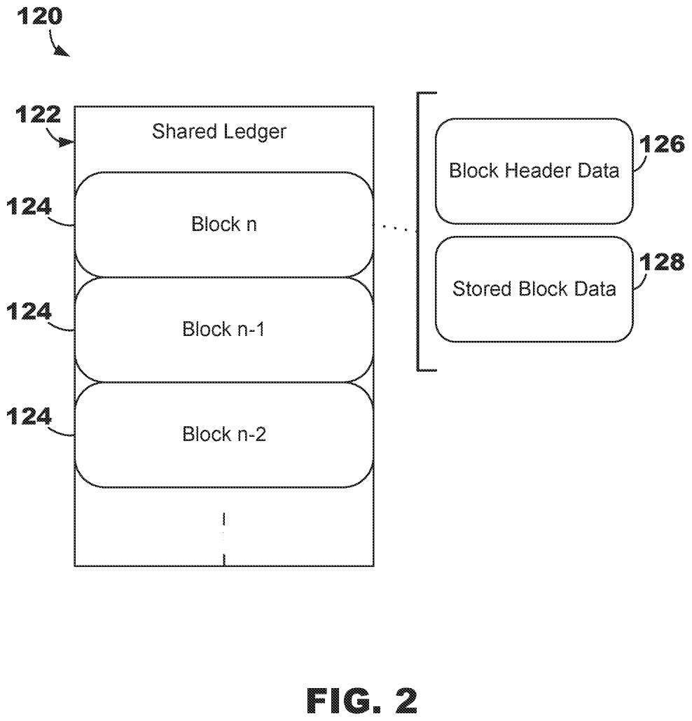

FIG. 2 is a conceptual diagram that illustrates one example of a ledger data structure 120 that may be used to store a shared ledger 122 usable in the system 100 of FIG. 1. As illustrated, the shared ledger 122 includes a plurality of blocks 124. Each of the blocks 124 stores ledger data. In some aspects, each of the blocks 124 is added to the shared ledger 122 one block at a time. For example, the blocks 124 may be added using a suitable blockchain technique.

Each of the blocks 124 may include various types of data. Some types of data may be described as block header data 126, or meta data. Another type of data may be described as stored block data 128. The stored block data 128 of each block 124 may include device health data.

In some aspects, two or more blocks 124 may be added to the shared ledger 122 concurrently in a pool, which may be described as a block pool. The block pool may share a single entry of block header data 126 relating to all the blocks 124 in the block pool. Once recorded, each of the blocks 124 may be addressed individually, even when recorded together in a pool.

In some aspects, the device health data may include drive health data, such as drive reliability data. Non-limiting examples of drive reliability data include S.M.A.R.T. data, a timestamp corresponding to when the S.M.A.R.T. data was generated, and a unique address or ID. The address or ID may include one or more of the following: a device ID of the respective electronic device, a subsystem ID associated with one or more electronic devices, a rack ID associated with one or more subsystems, or a datacenter ID associated with one or more racks. In some aspects, the address or ID may mask the physical location of the drive. For example, the address or ID may be a serial number or arbitrary ID, which may be associated with one or more other IDs in a database.

The block header data 126 of each block 124 may include various suitable information about one or more of the blocks. In some aspects, the block header data 126 may include one or more of the following: a previous block ID, a stored block ID, a current time (or timestamp), and a mining parameter.

A previous block ID may include a unique ID for one or more blocks already stored in the shared ledger 122. The previous block ID may be a cryptographic hash of some or all stored block data 128 and/or block header data 126 of the one or more blocks already stored in the shared ledger 122.

The stored block ID may include a unique ID for the block to be stored, or being stored, in the shared ledger 122. The block ID may be a cryptographic has of some or all stored block data 128 and/or other block header data 126 of the block to be stored, or being stored, in the shared ledger 122.

The current time, or timestamp, may include a time corresponding to when the stored block data 128 was generated, for example, by the electronic device node 104 (FIG. 1). The current time may also include a time corresponding to when the block to be stored, or being stored, is recorded to the shared ledger 122.

A mining parameter may include a target value, a nonce value, and a ledger update interval. These parameters may individually or cooperatively establish a difficulty for mining encrypted portions of the shared ledger 122.

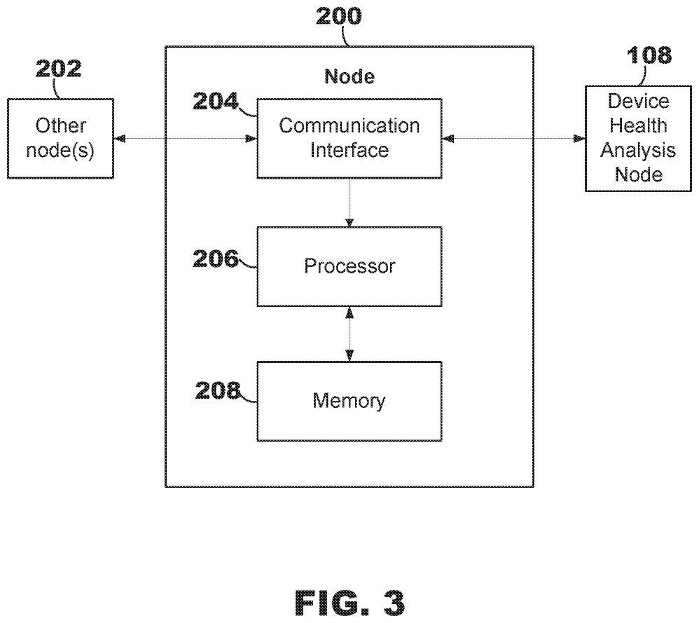

FIG. 3 is a conceptual diagram that illustrates one example of a node 200 usable in the system 100 of FIG. 1. The node 200 may be operably coupled to one or more other nodes 202. The node 200 may be operably coupled to the device health analysis node 108. The node 200 may be configured to transfer data to and from the one or more second nodes 202 and the device health analysis node 108. Each of the one or more other nodes 202 and the device health analysis node 108 may also be configured similarly to the node 200.

The node 200 may include one or more components to carry out various functionality. The node 200 may include a communication interface 204, a memory 208, and a processor 206 operably coupled to the communication interface 204 and the memory 208. Data may be provided from and received by the node 200 through the communication interface 204 in any suitable manner to one or more nodes. The processor 206 may process data in the memory 208 and/or data received by the communication interface 204, after which processed data may be provided back to the memory 208 or to the communication interface 204 to be provided to another node. The memory 208 may provide data to or store data from the processor 206, which may be processed or passed on by the processor 206 to the communication interface 204 or returned to the memory 208.

In some aspects, the node 200 may be configured to store a shared ledger 122 (FIG. 2), or a copy of the shared ledger, in memory 208. The shared ledger 122 may be accessed for reading by some or all of the one or more other nodes 202 or the electronic device node 108 using the communication interface 204 and the processor 206.

Data may be recorded to the shared ledger 122 by some or all of the one or more other nodes 202 or the electronic device node 108 using the communication interface 204 and the processor 206. In some embodiments, the electronic device node 108 is not able to record data to the shared ledger 122. In some aspects, the read or record access rights to the shared ledger 122 may be stored in the shared ledger 122 or in another data structure within the memory 208.

When recording one or more new blocks 124 (FIG. 2) to the shared ledger, the processor 206 may determine the block header data 126 (FIG. 2) to be recorded with the one or more blocks. The processor 206 may also generate a block pool based on two or more blocks 124.

In general, the functionality of systems and nodes described herein may be implemented using one or more computer programs using a computing apparatus, which may include one or more processors and/or memory. Program code and/or logic described herein may be applied to input data/information to perform functionality described herein and generate desired output data/information. The output data/information may be applied as an input to one or more other devices and/or methods as described herein or as would be applied in a known fashion. In view of the above, it will be readily apparent that the functionality as described herein may be implemented in any manner known to one skilled in the art having the benefit of the present disclosure.

One or more of the components of the system 100 (FIG. 1), such as a node, described herein may include a processor, such as a central processing unit (CPU), computer, logic array, or other device capable of directing data coming into or out of the respective node or system. In some aspects, the node may also be referred to as a controller. The node or controller may include one or more computing devices having memory, processing, and communication hardware. The node may include circuitry used to couple various components of the node together or with other components operably coupled to the node. The functions of the node may be performed by hardware and/or as computer instructions on a non-transient computer readable storage medium.

The processor 206 of the node 200 may include any one or more of a microprocessor, a microcontroller, a digital signal processor (DSP), an application specific integrated circuit (ASIC), a field-programmable gate array (FPGA), and/or equivalent discrete or integrated logic circuitry. In some examples, the processor 206 may include multiple components, such as any combination of one or more microprocessors, one or more controllers, one or more DSPs, one or more ASICs, and/or one or more FPGAs, as well as other discrete or integrated logic circuitry. The functions attributed to a node or processor herein may be embodied as software, firmware, hardware, or any combination thereof. While described herein as a processor-based system, an alternative node could utilize other components such as relays and timers to achieve the desired results, either alone or in combination with a microprocessor-based system.

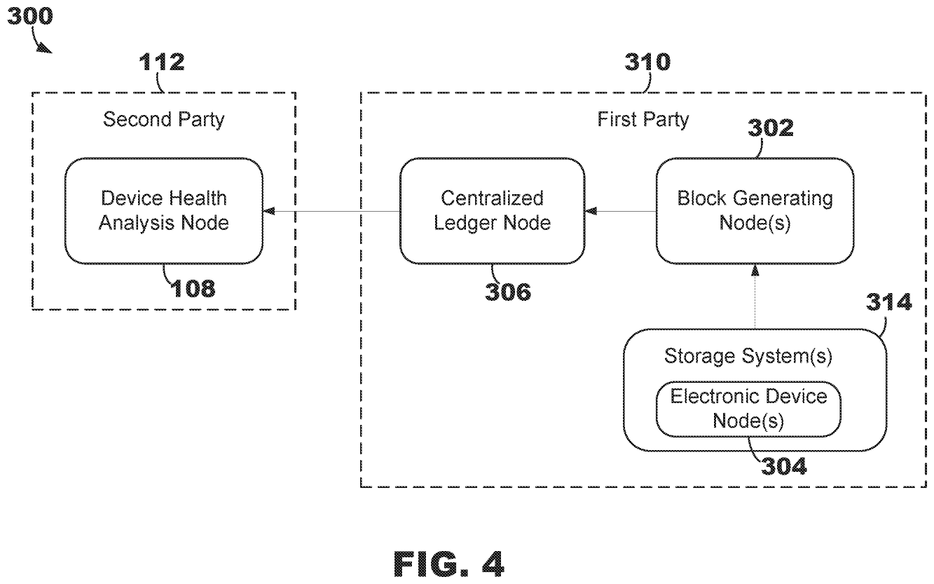

FIG. 4 is a conceptual diagram that illustrates one example of a centralized system 300 usable to configure the system 100 of FIG. 1. In general, the system 100 may be partially or fully centralized. In the illustrated embodiment, many of the parts and components depicted in FIG. 4 are the same or similar to those depicted in, and described with regard to, FIG. 2 Reference is made to the discussion above regarding FIG. 2 for numbered elements depicted in, but not specifically discussed with regard to, FIG. 4.

The centralized system 300 may include one or more block generating nodes 302, one or more electronic devices 304, a centralized ledger node 306, and the device health analysis node 108. In general, data transfer between various components of the centralized system 300 may include one-way communication or two-way communication. Each of the electronic devices 304 may be operably coupled to at least one block generating nodes 302 to transfer data, such as device health data, to at least one block generating node 302.

Each block generating node 302 may be operably coupled to the centralized ledger node 306 to transfer data, such as ledger data, from the block generating node 302 to the centralized ledger node 306. The centralized ledger node 306 may be operably coupled to the device health analysis node 108 to transfer data, such as ledger data, from the centralized ledger node 306 to the device health analysis node 108.

In some aspects, the one or more electronic devices 304 may provide the device health data to the block generating node 302 directly. In other aspects, device health data from each electronic device 304 may be generated and provided to system-level processing circuitry of a respective storage system 314. Each storage system 314 may be logically associated with, or defined as, one subsystem in a rack, multiple subsystems in a rack, one rack in a datacenter, or multiple racks in one or more datacenters. For example, the first party 310 may include one or more datacenters including one or more storage systems 314 and one or more electronic devices nodes 304. Different parties and different datacenters may be separated by geographic location or by firewall. The one or more electronic devices 304 may each be part of a storage system 314. In some aspects, each storage system 314 may include a plurality of electronic devices 304. At least one of the block generating nodes 302 may record the device health data, which may be encrypted, or may record pointers to device health data, to a shared ledger on the centralized ledger node 306.

The block generating nodes 302 may not be part of a storage system 314 (e.g., part of a different subsystem, rack, or datacenter). As such, each block generating node 302 may receive device health data from one or more electronic device nodes 304 or even from one or more storage systems 314.

In a fully centralized system, the only shared ledger may reside on the centralized ledger node 306. In partially centralized system, one or more copies of the shared ledger may also be replicated and stored elsewhere, for example, on one or more of the block generating nodes 302. In some cases, whether the system is fully centralized may depend on available processing resources and related considerations, such as transaction time or ledger size.

In the illustrated embodiment, the one or more block generating nodes 302, one or more electronic devices 304, and centralized ledger node 306 are part of a first party network 310. The shared ledger may be stored within the first party network 310. The device health analysis node 108 may be part of the second party network 112. Devices on the second party network 112 may have only read access to the shared ledger on the centralized ledger node 306. The second party network 112 may be unable to access any other data on the first party network 310, such as private data on the electronic device nodes 304.

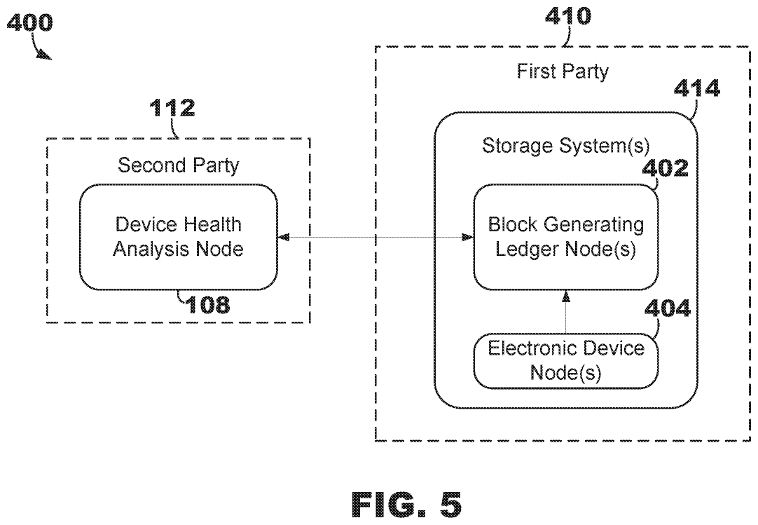

FIG. 5 is a conceptual diagram that illustrates one example of a decentralized system 400 usable to configure the system 100 of FIG. 1. In general, the system 100 may be partially or fully decentralized. In the illustrated embodiment, many of the parts and components depicted in FIG. 5 are the same or similar to those depicted in, and described with regard to, FIGS. 2 and 4. Reference is made to the discussion above regarding FIGS. 2 and 4 for numbered elements depicted in, but not specifically discussed with regard to, FIG. 5. The decentralized system 400 differs from the centralized system 300 (FIG. 4), for example, in that the decentralized system 400 includes block generating ledger nodes 402, which may store a copy of the shared ledger. The block generating nodes 302 (FIG. 4) of the centralized system 300 may not store a copy of the shared ledger.

The decentralized system 400 may include one or more block generating ledger nodes 402, one or more electronic devices 404, and the device health analysis node 108. In general, data transfer between various components of the decentralized system 400 may include one-way communication or two-way communication. The one or more electronic devices 404 may be operably coupled to the one or more block generating ledger nodes 402 to transfer data, such as device health data, to the one or more block generating ledger nodes 402. The one or more block generating ledger nodes 402 may be operably coupled to the device health analysis node 108 to transfer data, such as ledger data, from the one or more block generating ledger nodes 402 to the device health analysis node 108.

In some aspects, each of the one or more storage systems 414 may include one or more one or more electronic devices 404. Device health data generated by the one or more electronic devices 404 may be provided to the one or more block generating ledger nodes 402.

In the illustrated embodiment, each of the one or more storage systems 414 also includes one or more block generating ledger nodes 402. Each block generating ledger node 402 may receive device health data from one or more electronic device nodes 304 or even from one or more storage systems 414.

Each of the one or more block generating ledger nodes 402 may store a copy of the shared ledger and may provide the device health data to the device health analysis node 108. The one or more block generating ledger nodes 402 may record the device health data, which may be encrypted, or may record pointers to device health data, to the copy of the shared ledger.

In a fully decentralized system, every block generating ledger node 402 may replicate and store a copy of the shared ledger. In partially decentralized system, the shared ledger may only be replicated and stored on some of the block generating ledger nodes 402 (e.g., at least two or more) and optionally on a centralized ledger node also. In some cases, whether the system is fully decentralized may depend on available processing resources and related considerations, such as transaction time or ledger size.

In the illustrated embodiment, the one or more block generating ledger nodes 402 and the one or more electronic devices 404 are part of a first party network 410. The shared ledger may be stored within the first party network 410. The device health analysis node 108 may be part of the second party network 112. Devices on the second party network 112 may have only read access to the shared ledger on the one or more block generating ledger nodes 402. The second party network 112 may be unable to access any other data on the first party network 410, such as private data on the electronic device nodes 404.

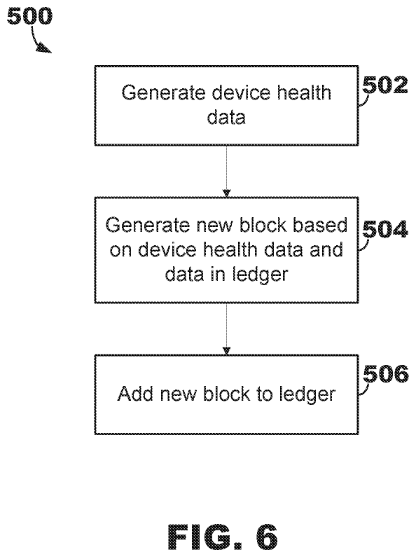

FIG. 6 is a flow diagram that illustrates one example of a blockchain verifying method 500 for ledger-based sharing of device health data usable with the system 100, the centralized system 300, or the decentralized system 400. As illustrated, the method 500 may include generating device health data in block 502. The method 500 may include generating a new block based on device health data and data in the ledger in block 504. The method 500 may include adding the newly generated block to the ledger in block 506. In general, the method 500 may use existing data in the shared ledger to generate each new block, which may facilitate determining data in the ledger has been altered.

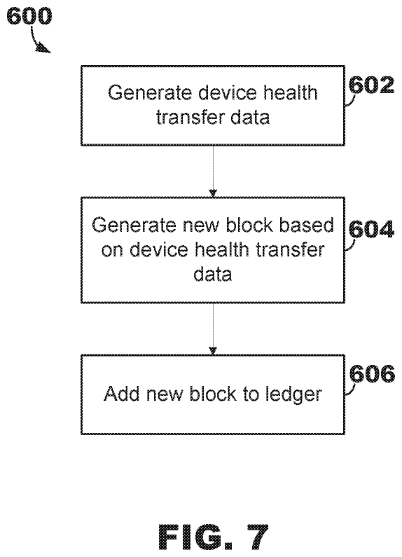

FIG. 7 is a flow diagram that illustrates one example of a transaction recording method for ledger-based sharing of device health data usable with the system 100, the centralized system 300, or the decentralized system 400. As illustrated, the method 600 may include generating device health sharing data in block 602. The method 600 may include generating a new block based on device health sharing data in block 604. The method 600 may include adding the newly generated block to the ledger in block 606. In general, the method 600 may use device health sharing data, including at least an address of a source node and/or a destination node and an ID of the data to be stored, to track transfers of data between the nodes. This record of transferred data may be used to determine which nodes have held the data. Use of a digital signature for each node, or other related cryptocurrency techniques known to one skilled in the art having the benefit of the present disclosure, may also be used.

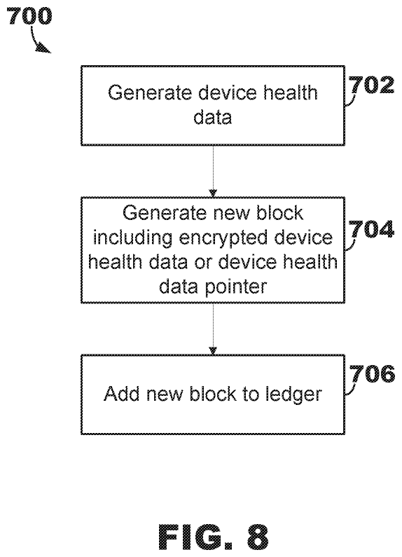

FIG. 8 is a flow diagram that illustrates one example of an encryption or pointer method for ledger-based sharing of device health data usable with the system 100, the centralized system 300, or the decentralized system 400. As illustrated, the method 700 may include generating device health data in block 702. The method 700 may include generating a new block including encrypted device health data or including one or more device health data pointers in block 704. The method 700 may include adding the newly generated block to the ledger in block 706. In general, the use of encrypted data or data pointers may facilitate further security of data stored in the ledger. For example, unauthorized users may not be able to decrypt data retrieved from the ledger or access the data structure indicated by the data pointers.

Thus, various embodiments of LEDGER-BASED DEVICE HEALTH DATA SHARING are disclosed. Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

All references and publications cited herein are expressly incorporated herein by reference in their entirety for all purposes, except to the extent any aspect directly contradicts this disclosure.

All scientific and technical terms used herein have meanings commonly used in the art unless otherwise specified. The definitions provided herein are to facilitate understanding of certain terms used frequently herein and are not meant to limit the scope of the present disclosure.

The terms “coupled” or “connected” refer to elements being attached to each other either directly (in direct contact with each other) or indirectly (having one or more elements between and attaching the two elements). Either term may be replaced to “couplable” or “connectable” to describe that the elements are configured to be coupled or connected. In addition, either term may be modified by “operatively” and “operably,” which may be used interchangeably, to describe that the coupling or connection is configured to allow the components to interact to carry out functionality.

As used herein, the term “configured to” may be used interchangeably with the terms “adapted to” or “structured to” unless the content of this disclosure clearly dictates otherwise.

The singular forms “a,” “an,” and “the” encompass embodiments having plural referents unless its context clearly dictates otherwise.

The term “or” is generally employed in its inclusive sense, for example, to mean “and/or” unless the context clearly dictates otherwise. The term “and/or” means one or all of the listed elements or a combination of at least two of the listed elements.

The phrases “at least one of,” “comprises at least one of,” and “one or more of” followed by a list refers to any one of the items in the list and any combination of two or more items in the list.

What is claimed is:

1. A system comprising:
an electronic device node configured to generate device health data indicative of electronic device health;
a ledger node configured to store a blockchain comprising one or more blocks; and
a block generating node configured to:
generate a new block based on the device health data and data corresponding to the one or more blocks in the blockchain; and
add the new block to the blockchain.

2. The system of claim 1, further comprising a device health analysis node operably coupled to the ledger node, the device health analysis node configured to determine a device health status based on at least part of the blockchain stored on the ledger node.

3. The system of claim 2, wherein the electronic device node is inaccessible by the device health analysis node.

4. The system of claim 1, wherein the data corresponding to the one or more blocks in the blockchain comprises a last block identifier.

5. The system of claim 1, wherein the one or more blocks each comprise one or more of the following: at least partial device health data, at least partial encrypted device health data, and one or more device health data pointers.

6. The system of claim 5, wherein each device health data pointer comprises an address of data in a device health data structure indicative of electronic device health stored on a device health storage node, wherein the device health data structure comprises one or more of the following: at least partial device health data and at least partial encrypted device health data.

7. The system of claim 1, wherein the block generating node is further configured to generate the new block based on a source node address and a destination node address corresponding to data indicative of electronic device health transferred from a source node to a destination node.

8. The system of claim 1, further comprising a plurality of ledger nodes including the ledger node each configured to store a copy of the blockchain.

9. The system of claim 1, wherein the electronic device node comprises a data storage device configured to store private data and the device health data, the private data being inaccessible by the block generating node.

10. An apparatus comprising:
memory configured to store a shared ledger comprising one or more blocks;
a communication interface operably configured to receive device health transfer data corresponding to data indicative of electronic device health transferred from a source node to a destination node, the device health transfer data comprising the data indicative of electronic device health, a source node address, and a destination node address; and
processing circuitry operably coupled to the memory and the communication interface configured to:
generate a new block based on the device health transfer data; and
add the new block to the shared ledger.

11. The apparatus of claim 10, wherein the communication interface is operably coupled to a device health analysis node and the processing circuitry is further configured to provide at least part of the shared ledger to the device health analysis node using the communication interface.

12. The apparatus of claim 10, wherein the shared ledger is configured as a blockchain and wherein, to generate a new block, the processing circuitry is configured to generate the new block based on the device health transfer data and data corresponding to the one or more blocks in the shared ledger.

13. The apparatus of claim 10, wherein the one or more blocks each comprise one or more of the following: at least partial device health data, at least partial encrypted device health data, and a device health data pointer.

14. The apparatus of claim 13, wherein the device health data pointer comprises an address of data in a device health data structure indicative of electronic device health stored on a device health storage node, wherein the device health data structure comprises one or more of the following: at least partial device health data and at least partial encrypted device health data.

15. A method comprising:
generating device health data indicative of electronic device health of an electronic device;
generating a new block comprising at least partial encrypted device health data or one or more device health data pointers based on at least part of the device health data;
adding the new block to a shared ledger stored on a ledger node; and
sending at least part of the shared ledger to a device health analysis node remote from the ledger node, the electronic device being inaccessible by the device health analysis node.

16. The method of claim 15, further comprising determining a device health status of the electronic device using the device health analysis node based on at least part of the shared ledger.

17. The method of claim 16, wherein determining the device health status comprises decrypting at least part of the shared ledger using a private key used by a private node to generate the at least partial encrypted device health data.

18. The method of claim 15, wherein the shared ledger is configured as a blockchain and wherein generating the new block comprises generating the new block based on data corresponding to one or more blocks of the shared ledger.

19. The method of claim 15, wherein generating the new block comprises generating the new block based on a source node address and a destination node address corresponding to transferring data indicative of electronic device health from a source node to a destination node.

20. The method of claim 15, wherein each device health data pointer comprises an address of data in a device health data structure indicative of electronic device health stored on a device health storage node, wherein the device health data structure comprises one or more of the following: at least partial device health data and at least partial encrypted device health data.
